(19) United States
(12) Patent Application Publication
(10) Pub. No.: US 2009/0303729 A1
(43) Pub. Date: Dec. 10, 2009

(54) Light Emitting Diode Lamp-Set

(76) Inventor: Chin-Pin Liao, Sinjhuang City (TW)

Correspondence Address: Troxell Law Office Pllc;Suite 1404, 5205 Leesburg Pike, Falls Church, VA, 22041, US

(21) Appl. No.: 12/134,303

(22) Filed: Jun. 6, 2008

(51) Int. Cl. F21V 29/00; F21V 1/00

(52) U.S. Cl. 362/311.01; 362/294

(57) ABSTRACT

A light emitting diode lamp-set includes a shell, at least one module block, a light source device and a lamp shade. An interior of the lamp shell is defined into a holding space, the holding space is installed with the module blocks (such as circular, elliptical or polygonal blocks), the module blocks are assembled into surfaces of different angles from various configurations, and the surfaces assembled by the module blocks are adhered with at least one light source device (such as LED lamps). As the LED lamps emit straight light, the LED lamps on the module blocks can project the light in a wide angle by changing different surfaces. Thus, an assembly mode of the module blocks is changed freely according to environment or a purpose of utilization, to increase or decrease a projection surface of different angle, which provides a user with a more diversified way of utilization.

### BACKGROUND OF THE INVENTION

a) Field of the Invention

The present invention relates to a light emitting diode lamp-set, and more particularly to a light emitting diode lamp-set, which allows a user to change freely an assembly mode of module blocks according to environment or a purpose of utilization, so as to increase or decrease a projection surface of different angle, thereby providing the user with a more diversified way of utilization.

b) Description of the Prior Art

As a light emitting diode (LED) is a solid-state semiconductor element which uses mutual collaboration of electrons and holes to release energy in a form of light, belonging to photoluminescence lighting, it is provided with advantages of a small volume, a fast reaction speed, a long lifetime of usage, low consumption of electricity, a good vibration-proof feature and having no pollution, thereby being used as a light emitting element for all kinds of electric appliances, information display panels or communication products. Until now, the LED has already been broadly applied in each field, especially being used as a light emitting element in existing illuminating equipment. Although an efficiency of the early LED is not as good as that of the conventional illuminating equipment, brightness of the light emitting diode has been progressed significantly under succeeding improvement of technology and materials; and therefore the conventional illuminating element has been gradually replaced by the light emitting diode.

Accordingly, most of LED lamps sold on existing markets are primarily a straight-light type. Therefore, when this kind of LED lamp is to be installed on an ordinary planar base, its brightness will be largely increased; however, as light is projected out along a same direction, ambient environment will not receive the same brightness, which will largely reduce practicability for a lamp-set used in a special purpose and place. Therefore, there are vendors who use a different approach on the base. Referring to FIG. 1, it shows a conventional light emitting diode lamp-set 1 which includes a shell 10, a light source device 11, a lamp shade 12 and a substrate 13, wherein the substrate 13 is provided with the light source device 11 and a surface of the light source device 11 is provided with more than one LED lamp 14. Therefore, when the light emitting diode lamp-set 1 is activated, the irradiation brightness of the light emitting diode lamp-set 1 is improved significantly, as the LED lamps 14 on the light source device 11 are all irradiating toward a same direction.

However, upon using the aforementioned light emitting diode lamp-set, following problems and shortcomings actually exist to be improved.

As the LED lamp 14 inside the light emitting diode lamp-set 1 emits the straight light and is installed on the substrate 13, a range of projection is only limited to a fixed angle when the LED lamp 14 is illuminating. Therefore, when proceeding illumination at various orientations according to a different need and a different place, a user has to prepare more light emitting diode lamp-sets 1 to illuminate toward different orientations, which is rather inconvenient.

Accordingly, how to solve the aforementioned problems and shortcomings of the prior art, is a technological issue of research and development for improvement by the present inventor and related vendors.

### SUMMARY OF THE INVENTION

The primary object of the present invention is to provide a light emitting diode lamp-set which comprises a shell, at least one module block, a light source device and a lamp shade, wherein an interior of the lamp shell is defined into a holding space and interior of which is provided with the module blocks (such as circular, elliptical or polygonal blocks) forming into surfaces of different angles from various configurations. In addition, the surfaces that are assembled by the module blocks can be adhered with at least one light source device. Accordingly, the user can change freely an assembly mode of the module blocks according to environment or a purpose of utilization, so as to increase or decrease a projection surface of different angle, thereby providing the user with a more diversified way of utilization.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional light emitting diode lamp-set.

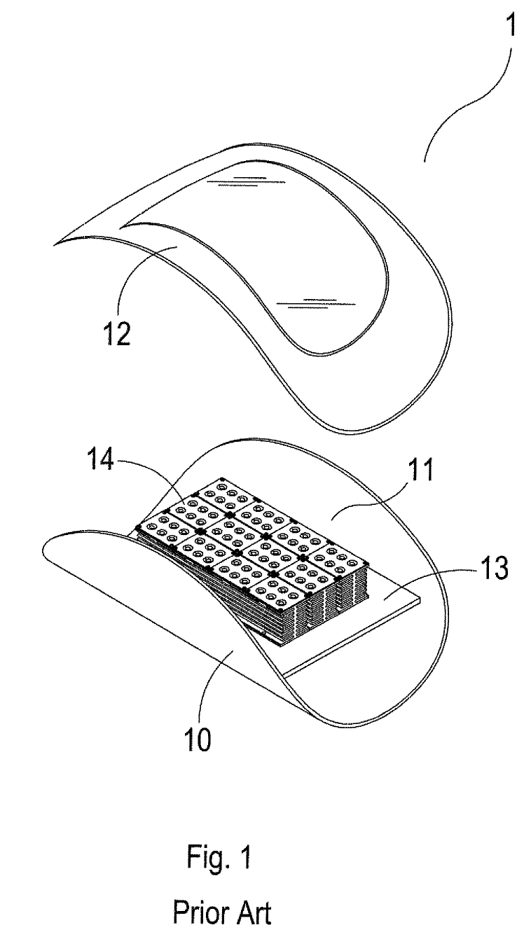

FIG. 2 shows a perspective view of a preferred embodiment of the present invention.

FIG. 3 shows an exploded view of a preferred embodiment of the present invention.

FIG. 4 shows a first schematic view of an operation of a preferred embodiment of the present invention.

FIG. 5 shows a second schematic view of an operation of a preferred embodiment of the present invention.

FIG. 6 shows a third schematic view of an operation of a preferred embodiment of the present invention.

FIG. 7 shows a schematic view of another preferred embodiment of the present invention.

FIG. 8 shows a schematic view of still another preferred embodiment of the present invention.

### DETAILED DESCRIPTION OF THE PREFERRED EMBODIMENTS

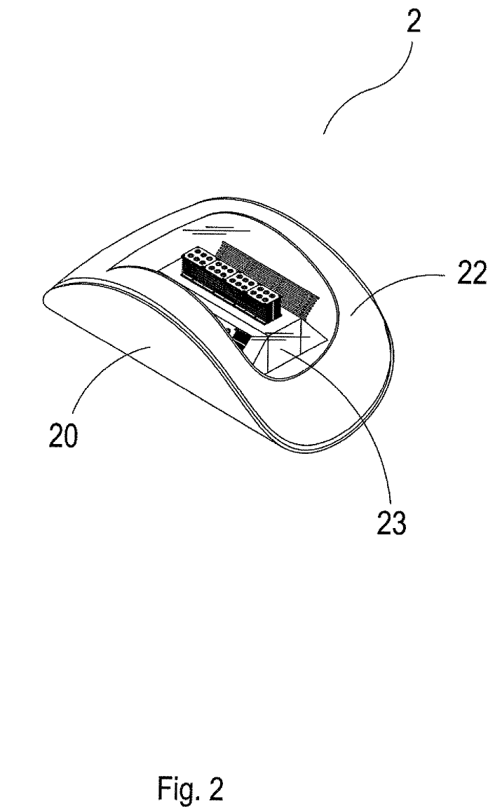

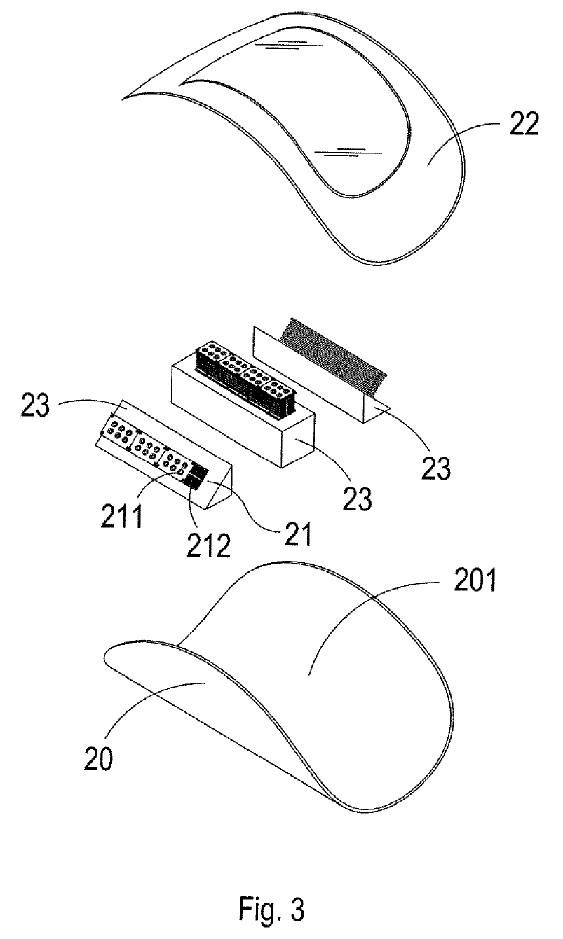

Referring to FIG. 2 and FIG. 3, it shows a schematic view and an exploded view of a preferred embodiment of the present invention. A light emitting diode lamp-set 2 of the present invention comprises a shell 20, a light source device 21, a lamp shade 22 and at least one module block 23, wherein an interior of the lamp shell 20 is defined into a holding space 201, an interior of the holding space 201 is provided with the module blocks 23 (such as circular, elliptical or polygonal blocks), surfaces of different angles are assembled by the module blocks 23 from various configurations, and the surfaces that are assembled by the module blocks 23 are adhered with at least one light source device 21 which is constituted by a light emitting diode 211 and a heat conduction part 212.

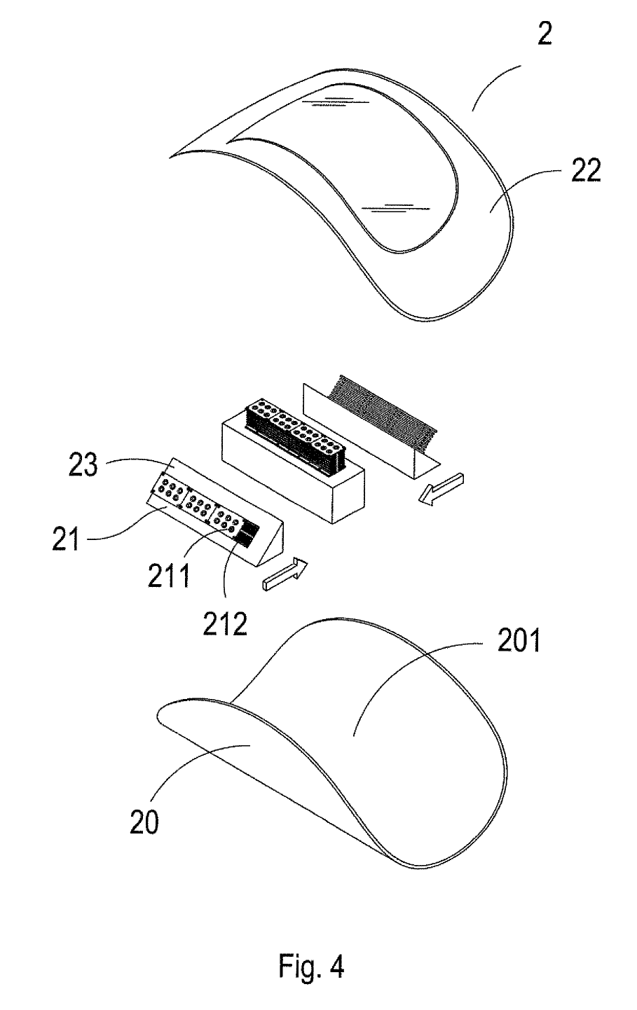

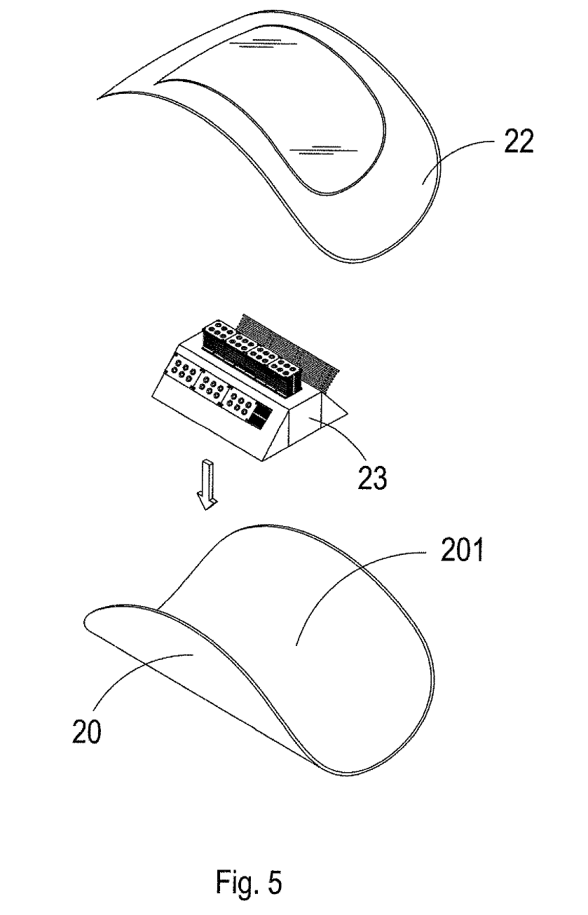

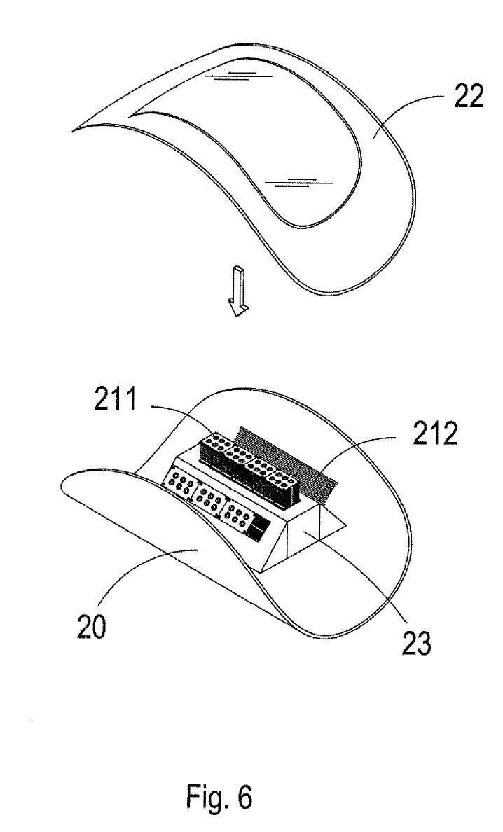

Referring to FIGS. 4 to 6, it shows a first schematic view of an operation, a second schematic view of an operation and a third schematic view of an operation, of a preferred embodiment of the present invention. When the present invention is to be assembled, the surfaces of different angles are assembled by various configurations of the module blocks 23, the surfaces that are assembled by the module blocks 23 are adhered with at least one light source device 21 and the module blocks 23 that are provided with the light source devices 21 are fixed in the holding space 201 inside the shell 20. Thus, a user can increase, decrease and change at any time an assembly state of the module blocks 23 in the light emitting diode lamp-set 2 according to environment or a purpose of utilization, enabling the light source devices 21 on the module blocks 23 to project the light in a wide angle through a variation of different surfaces, so as to comply with the user's need.

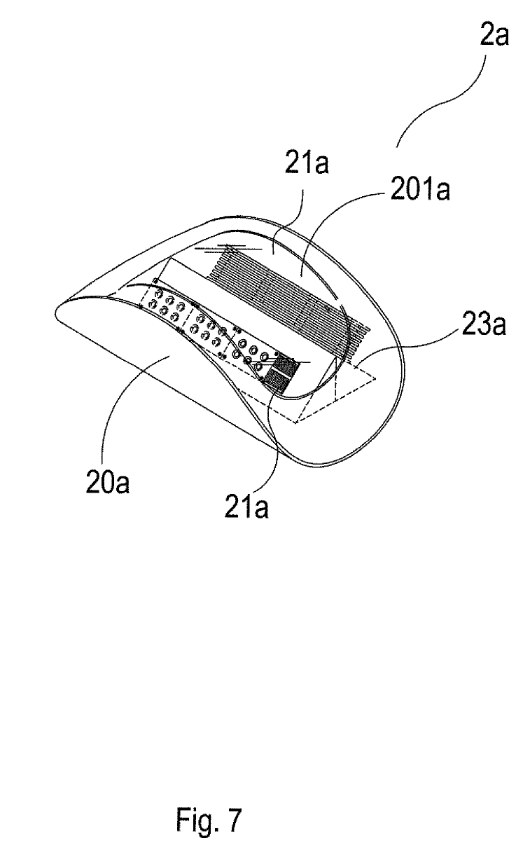

Referring to FIG. 7, it shows a schematic view of another preferred embodiment of the present invention. Module blocks 23a can be also installed in a holding space 201a inside a shell 20a individually, each surface on the module block 23a is provided with a light source device 21a and then the module blocks 23a that are provided with the light source devices 21a are fixed in the holding space 201a inside the shell 20a. Accordingly, this kind of installation method can be also applied in a special situation, allowing the user to choose and assemble for use any two module blocks 23a of a same configuration in the holding space 201a of the shell 20a, which enables a light emitting diode lamp-set 2a to be formed as a fixed illuminating device depending on an area to be projected required by the user.

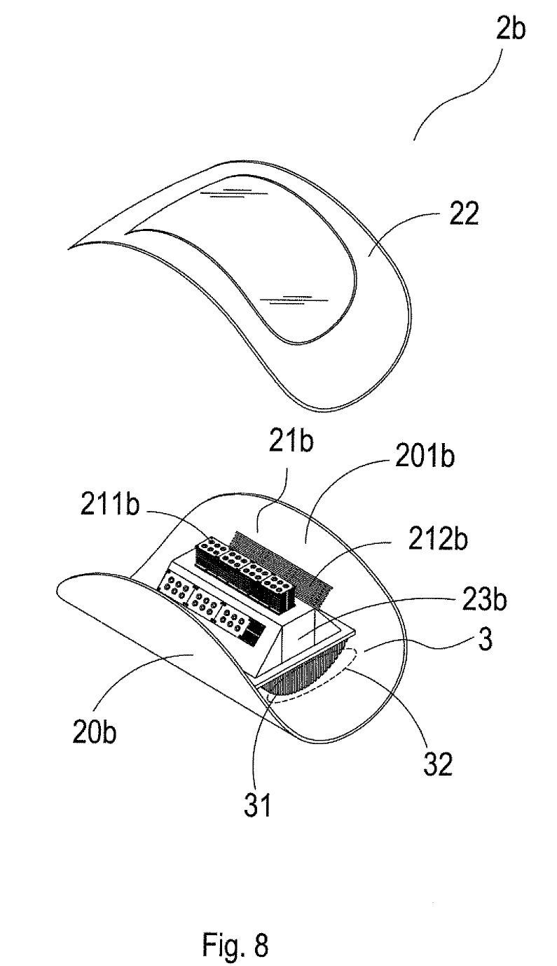

The present invention can be also added with an ordinary heat conduction part. Referring to FIG. 8, it shows a schematic view of still another preferred embodiment of the present invention. A holding space 201b in a light emitting diode lamp-set 2b is installed with module blocks 23b of different angles assembled by various configurations, a bottom of each module block 23b is added with a heat dissipation part 3 to enhance a heat dissipation effect and then a heat area 32 which is formed at a bottom of the heat dissipation part 3 is assembled to a shell 20b with a heat paste, such that the large area heat area 32 can be in contact with the shell 20b. Thus, when light emitting diodes 211b of a plurality of light source devices 21b are illuminating, heat energy produced by the light emitting diodes 211b will be transmitted from heat conduction parts 212b to the module blocks 23b, and then be vertically conducted to the heat dissipation parts 3 through the module blocks 23b. Due to that the heat area 32 is formed by a plurality of fins 31 at a bottom of the heat dissipation part 3, the heat energy is conducted to the shell 20b of the light emitting diode lamp-set 2b and can be exchanged with outside cold air through the shell 20b, so as to achieve an effect of quickly assisting the heat area 32 for dissipating the heat, thereby effectively dissipating out the heat produced by the light emitting diodes 211b of the plural light source devices 21b rapidly, without allowing the heat to be accumulated inside the light emitting diode lamp-set 2b and the heat areas 32. On the other hand, in daytime, when an exterior of the shell 20b is exposed to induce excessively high temperature, the excessively high temperature can be also absorbed by the heat areas 32, avoiding heat sources to be accumulated at the light source devices 21b, thereby adjusting and buffering temperature of the holding space 201b inside the light emitting diode lamp-set 2b to prevent the temperature from rising and dropping abruptly that the plural light source devices 21b can be aging and degraded easily.

Referring to all the drawings, the present invention is actually provided with an advantage in comparison with the prior art upon using, which is that the user can change freely an assembly mode of the module blocks 23 according to environment or a purpose of utilization, to increase or decrease a projection surface of different angle, thereby providing the user with a more diversified state of utilization.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A light emitting diode lamp-set comprising a shell, at least one module block, a light source device and a lamp shade, wherein an interior of the lamp shell is defined into a holding space, an interior of the holding space is installed with the module blocks, the module blocks are assembled into surfaces of different angles from various configurations, and the surfaces that are assembled by the module blocks are adhered with at least one light source device.

2. The light emitting diode lamp-set according to claim 1, wherein the module blocks are in a circular, elliptical or polygonal shape.

3. The light emitting diode lamp-set according to claim 1, wherein the light source device is constituted by a light emitting diode and a heat conduction pad.
